(19) United States
(12) Patent Application Publication
(10) Pub. No.: US 2017/0300499 A1
(43) Pub. Date: Oct. 19, 2017

(54) QUALITY MONITORING AUTOMATION IN CONTACT CENTERS

(71) Applicant: Genesys Telecommunications Laboratories, Inc., Daly City, CA (US)

(72) Inventors: Amir Lev-Tov, Bat-Yam (IL); Tamir Tapuhi, Ashdod (IL); Avraham Faizakof, Kefar Varburg (IL); David Konig, Tel-Aviv (IL); Yochai Konig, San Francisco, CA (US)

(21) Appl. No.: 15/133,188

(22) Filed: Apr. 19, 2016

(51) Int. Cl. G06F 17/30; G06F 17/24; G06F 17/21; G06F 3/0481

(52) U.S. Cl. CPC G06F 17/3069; G06F 17/30716; G06F 3/04817; G06F 17/212; G06F 17/243

(57) ABSTRACT

A method includes: receiving, by a processor, a question including text; identifying, by the processor, one or more identified topics from a plurality of tracked topics tracked by an analytics system in accordance with the text of the question, the analytics system being configured to perform analytics on a plurality of interactions with a plurality of agents of a contact center; outputting, by the processor, the one or more identified topics; associating, by the processor, one or more selected topics with the question, the selected topics one or more of the identified topics; adding, by the processor, the question and the selected topics to the evaluation form; and outputting the evaluation form.

### FIELD

Aspects of embodiments of the present invention relate to the field of software for operating contact centers, in particular, software for performing speech recognition and analytics on voice interactions occurring in a contact center and for monitoring and controlling the operation of the contact center in accordance with the analytics.

### BACKGROUND

Generally, a contact center is staffed with agents who serve as an interface between an organization, such as a company, and outside entities, such as customers. For example, human sales agents at contact centers may assist customers in making purchasing decisions and may receive purchase orders from those customers. Similarly, human support agents at contact centers may assist customers in resolving issues with products or services provided by the organization. Interactions between contact center agents and outside entities (customers) may be conducted by voice (e.g., telephone calls or voice over IP or VoIP calls), video (e.g., video conferencing), text (e.g., emails and text chat), or through other media.

Quality monitoring in contact centers refers to the process of evaluating agents and ensuring that the agents are providing sufficiently high quality service. Generally, a quality monitoring process will monitor the performance of an agent by evaluating the interactions that the agent participated in for events such as whether the agent was polite and courteous, whether the agent was efficient, and whether the agent proposed the correct solutions to resolve a customer's issue.

### SUMMARY

Aspects of embodiments of the present invention are directed to systems and methods for using text and speech analytics to automatically provide suggestions in a contact center quality monitoring system. In various aspects of embodiments of the present invention, these suggestions may be supplied when authoring evaluation forms, when performing assignments of interactions for review to evaluators, and when performing evaluations.

According to one embodiment, a method includes: receiving, by a processor, a question including text; identifying, by the processor, one or more identified topics from a plurality of tracked topics tracked by an analytics system in accordance with the text of the question, the analytics system being configured to perform analytics on a plurality of interactions with a plurality of agents of a contact center; outputting, by the processor, the one or more identified topics; associating, by the processor, one or more selected topics with the question, the selected topics one or more of the identified topics; adding, by the processor, the question and the selected topics to the evaluation form; and outputting the evaluation form.

The identifying the one or more identified topics from a plurality of tracked topics tracked by the analytics system in accordance with the text of the question may include, for each topic of the plurality of tracked topics: computing a question-topic similarity metric between the text of the question and the topic; and connecting the topic to the question when the question-topic similarity metric exceeds a threshold.

The computing the question-topic similarity metric between the text of the question and the topic may include: computing a plurality of word similarity metrics, each word similarity metric corresponding to a similarity between a stemmed word of the text of the question and a most similar stemmed word in the topic; and summing the plurality of word similarity metrics to compute the question-topic similarity metric.

The method may further include: normalizing the question-topic similarity metric by a number of unique stemmed words in the text of the question.

The method may further include receiving a data type of answers to the question, the data type being one of: a yes/no data type; a multiple response data type; a numerical value data type; and a free text data type.

The method may further include: associating the evaluation form with an evaluation session; associating one or more interactions to the evaluation session; and identifying and associating one or more evaluators to the evaluation session.

According to one embodiment of the present invention, a method for evaluating an interaction between a customer and an agent of a contact center includes: outputting, by a processor, an evaluation form including a plurality of questions, each of the plurality of questions being associated with one or more question topics; outputting, by the processor, the interaction, the interaction being associated with one or more interaction topics, each of the one or more interaction topics being associated with at least one portion of the interaction; and for each question of the plurality of questions: identifying, by the processor, at least one portion of the interaction relevant to the question, the at least one portion corresponding to one of the interaction topics, wherein the one of the interaction topics corresponds to one of the question topics; and receiving, by the processor, an answer to the question.

The identifying the at least one portion of the interaction relevant to the question may include highlighting the at least one portion on a user interface device.

The identifying the at least one portion of the interaction relevant to the question may include displaying a representation of the interaction on a user interface device and displaying at least one icon at location of the representation of the interaction corresponding to the at least one portion.

The interaction may be a recording, and the identifying the at least one portion of the interaction relevant to the question may include automatically playing back the relevant portion of the interaction.

The method may further include, for each question of the questions: determining whether question is relevant to the interaction; and hiding the question when the question is irrelevant to the interaction.

When the question is a multiple response question including a plurality of answers, each of the answers of the multiple response question may be associated with one or more question-answer topics, and the identifying, by the processor, at least one portion of the interaction relevant to the question may include identifying at least one portion corresponding to one of the interaction topics corresponding to one of the question-answer topics.

According to one embodiment of the present invention, a method for evaluating an interaction in accordance with an evaluation form including a plurality of questions may include: for each current question of the plurality of questions: generating a query in accordance with the current question and the interaction; querying a knowledge base based on the question and the interaction, the knowledge base including an index of a plurality of triples, each triple including a question, an answer, and an interaction document; identifying a closest matching triple of the plurality of triples of the knowledge base in accordance with the current question and the interaction; and outputting the answer of the closest matching triple.

The knowledge base may be generated from a plurality of evaluations of a plurality of previously evaluated interactions.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic block diagram of a system for supporting a contact center in providing contact center services according to one exemplary embodiment of the invention.

FIG. 2 is a flowchart illustrating a method for quality monitoring according to one embodiment of the present invention.

FIG. 3 is a block diagram illustrating a quality monitoring module according to one embodiment of the present invention.

FIG. 4A is a screenshot illustrating a user interface associated with the evaluation form designer interface according to one embodiment of the present invention, where the interface shows a plurality of questions that can be have the order of the questions changed.

FIGS. 4B and 4C are screenshots illustrating a user interface associated with the evaluation form designer interface according to one embodiment of the present invention, where the user interface shows the insertion of a new question to the evaluation form and the selection of a question type.

FIG. 4D is a screenshot illustrating a user interface associated with the evaluation session assigner interface according to one embodiment of the present invention, where potential evaluators are listed.

FIG. 4E is a screenshot illustrating a user interface associated with the evaluation session assigner interface according to one embodiment of the present invention, where the user interface accepts particular criteria to use for searched for interactions and filtering the interactions by the supplied criteria.

FIG. 4F is a screenshot illustrating a user interface for an interaction evaluation, where the screenshot shows a current question being answered and an indication of a particular portion of the interaction that has automatically been identified is likely to be relevant to answering the question.

FIG. 5A is a flowchart illustrating a method for generating suggestions for a form developer in a form designer interface 47ai according to one embodiment of the present invention.

FIG. 5B is a flowchart illustrating the computation of whether or not to make a connection between a question q and a topic t according to one embodiment of the present invention.

FIG. 6 is a flowchart illustrating a method 600 for assigning interactions to an evaluation session according to one embodiment of the present invention.

FIG. 7 is a flowchart illustrating a method for providing suggestions of portions of an interaction containing an answer to a question according to one embodiment of the present invention.

FIG. 8 is a flowchart illustrating a method for training a Knowledge Base according to one embodiment of the present invention.

FIG. 9 is a flowchart illustrating a method for querying a Knowledge Base according to one embodiment of the present invention.

FIG. 10A is a block diagram of a computing device according to an embodiment of the present invention.

FIG. 10B is a block diagram of a computing device according to an embodiment of the present invention.

FIG. 10C is a block diagram of a computing device according to an embodiment of the present invention.

FIG. 10D is a block diagram of a computing device according to an embodiment of the present invention.

FIG. 10E is a block diagram of a network environment including several computing devices according to an embodiment of the present invention.

### DETAILED DESCRIPTION

Quality monitoring (QM) in a contact center refers to the process of evaluating agents to measure and ensure the quality of the service provided by the human agents. Typically, quality management is performed to measure agent performance during interactions (e.g., calls, text chats, and email exchanges) between the agents and customers, such as whether the agent was polite and courteous, and to measure agent effectiveness, such as whether the agent was able to resolve the customer's issue and whether the agent was time efficient in doing so.

Systems for quality monitoring or quality management are described in U.S. patent application Ser. No. 14/726,491 “System and Method for Quality Management Platform,” filed in the United States Patent and Trademark Office on May 30, 2015, the entire disclosure of which is incorporated by reference herein.

Broadly, performing quality monitoring according to one embodiment of the present invention broadly involves three stages: 1) generating the evaluation form; 2) assigning interactions to evaluation sessions and evaluation sessions to evaluators; and 3) performing the evaluation sessions. These will be described in more detail below.

### Contact Center Overview

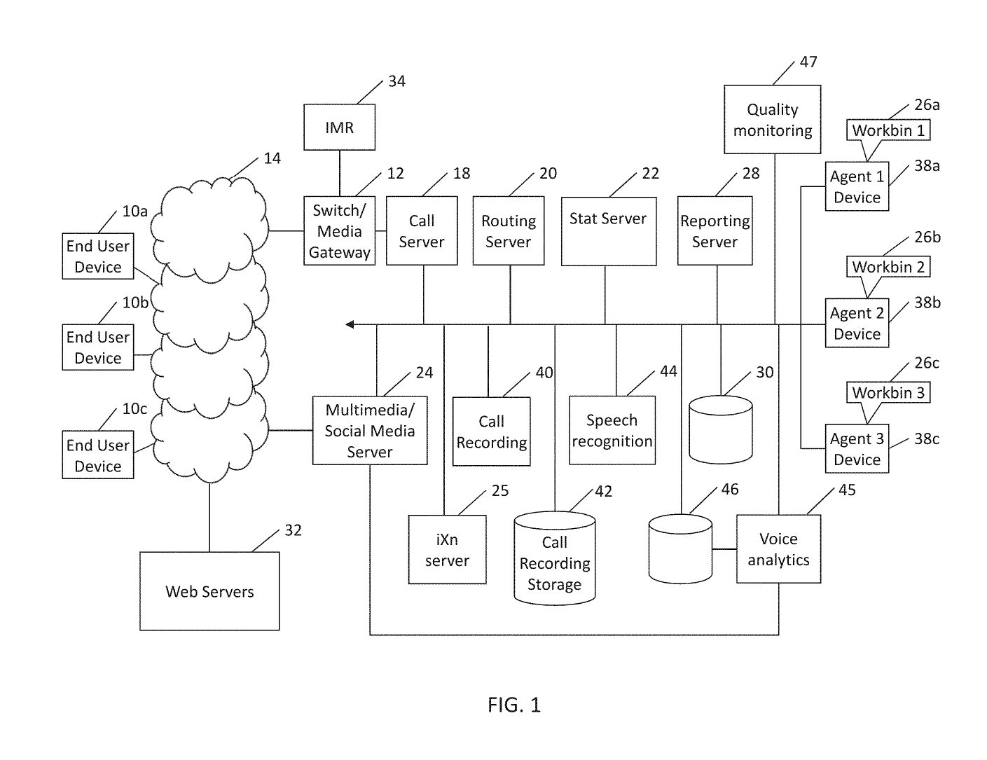

FIG. 1 is a schematic block diagram of a system for supporting a contact center in providing contact center services according to one exemplary embodiment of the invention. For the purposes of the discussion herein, interactions between customers using end user devices 10 and agents at a contact center using agent devices 38 may be recorded by call recording module 40 and stored in call recording storage 42. The recorded calls may be processed by speech recognition module 44 to generate recognized text which is stored in recognized text storage 46. In some embodiments of the present invention, a voice analytics system 45 configured to perform analytics on recognized speech data such as by detecting events occurring in the interactions and categorizing the interactions in accordance with the detected events. Aspects of speech analytics systems are described, for example, in U.S. patent application Ser. No. 14/586,730 “System and Method for Interactive Multi-Resolution Topic Detection and Tracking,” filed in the United States Patent and Trademark Office on Dec. 30, 2014, the entire disclosure of which is incorporated herein by reference. Embodiments of the present invention may also include a quality monitoring (QM) system 47, which will be described in more detail below.

The contact center may be an in-house facility to a business or corporation for serving the enterprise in performing the functions of sales and service relative to the products and services available through the enterprise. In another aspect, the contact center may be a third-party service provider. The contact center may be deployed in equipment dedicated to the enterprise or third-party service provider, and/or deployed in a remote computing environment such as, for example, a private or public cloud environment with infrastructure for supporting multiple contact centers for multiple enterprises. The various components of the contact center system may also be distributed across various geographic locations and computing environments and not necessarily contained in a single location, computing environment, or even computing device.

According to one exemplary embodiment, the contact center system manages resources (e.g. personnel, computers, and telecommunication equipment) to enable delivery of services via telephone or other communication mechanisms. Such services may vary depending on the type of contact center, and may range from customer service to help desk, emergency response, telemarketing, order taking, and the like.

Customers, potential customers, or other end users (collectively referred to as customers) desiring to receive services from the contact center may initiate inbound telephony calls to the contact center via their end user devices 10a-10c (collectively referenced as 10). Each of the end user devices 10 may be a communication device conventional in the art, such as, for example, a telephone, wireless phone, smart phone, personal computer, electronic tablet, and/or the like. Users operating the end user devices 10 may initiate, manage, and respond to telephone calls, emails, chats, text messaging, web-browsing sessions, and other multi-media transactions.

Inbound and outbound telephony calls from and to the end users devices 10 may traverse a telephone, cellular, and/or data communication network 14 depending on the type of device that is being used. For example, the communications network 14 may include a private or public switched telephone network (PSTN), local area network (LAN), private wide area network (WAN), and/or public wide area network such as, for example, the Internet. The communications network 14 may also include a wireless carrier network including a code division multiple access (CDMA) network, global system for mobile communications (GSM) network, or any wireless network/technology conventional in the art, including but to limited to 3G, 4G, LTE, and the like.

According to one exemplary embodiment, the contact center includes a switch/media gateway 12 coupled to the communications network 14 for receiving and transmitting telephony calls between end users and the contact center. The switch/media gateway 12 may include a telephony switch configured to function as a central switch for agent level routing within the center. The switch may be a hardware switching system or a soft switch implemented via software. For example, the switch 12 may include an automatic call distributor, a private branch exchange (PBX), an IP-based software switch, and/or any other switch configured to receive Internet-sourced calls and/or telephone network-sourced calls from a customer, and route those calls to, for example, an agent telephony device. In this example, the switch/media gateway establishes a voice path/connection (not shown) between the calling customer and the agent telephony device, by establishing, for example, a connection between the customer's telephony device and the agent telephony device.

According to one exemplary embodiment of the invention, the switch is coupled to a call server 18 which may, for example, serve as an adapter or interface between the switch and the remainder of the routing, monitoring, and other call-handling components of the contact center.

The call server 102 may be configured to process PSTN calls, VoIP calls, and the like. For example, the call server 102 may include a session initiation protocol (SIP) server for processing SIP calls. According to some exemplary embodiments, the call server 102 may, for example, extract data about the customer interaction such as the caller's telephone number, often known as the automatic number identification (ANI) number, or the customer's internet protocol (IP) address, or email address, and communicate with other CC components and/or CC iXn controller 18 in processing the call.

According to one exemplary embodiment of the invention, the system further includes an interactive media response (IMR) server 34, which may also be referred to as a self-help system, virtual assistant, or the like. The IMR server 34 may be similar to an interactive voice response (IVR) server, except that the IMR server is not restricted to voice, but may cover a variety of media channels including voice. Taking voice as an example, however, the IMR server may be configured with an IMR script for querying calling customers on their needs. For example, a contact center for a bank may tell callers, via the IMR script, to “press 1” if they wish to get an account balance. If this is the case, through continued interaction with the IMR, customers may complete service without needing to speak with an agent. The IMR server 34 may also ask an open ended question such as, for example, “How may I assist you?” and the customer may speak or otherwise enter a reason for contacting the contact center. The customer's speech may then be processed by the speech recognition module 44 and the customer's response may then be used by the routing server 20 to route the call to an appropriate contact center resource.

In more detail, a speech driven IMR receives audio containing speech from a user. The speech is then processed to find phrases and the phrases are matched with one or more speech recognition grammars to identify an action to take in response to the user's speech. As used herein, the term “phrases” may also include “fragments” in which words are extracted from utterances that are not necessarily sequential. As such, the term “phrase” includes portions or fragments of transcribed utterances that omit some words (e.g., repeated words and words with low saliency such as “um” and “ah”). For example, if a user says “what is my account balance?” then the speech driven IMR may attempt to match phrases detected in the audio (e.g., the phrase “account balance”) with existing grammars associated with actions such as account balance, recent transactions, making payments, transferring funds, and connecting to a human customer service agent. Each grammar may encode a variety of ways in which customers may request a particular action. For example, an account balance request may match phrases such as “account balance,” “account status,” “how much money is in my accounts,” and “what is my balance.” Once a match between the spoken phrase from the user and a grammar is detected, the action associated with the grammar is performed in a manner similar to the receiving a user selection of an action through a keypress. These actions may include, for example, a VoiceXML response that is dynamically generated based on the user's request and based on stored business information (e.g., account balances and transaction records).

In some embodiments, the speech recognition module 44 may also operate during a voice interaction between a customer and a live human agent in order to perform analytics on the voice interactions. During a voice interaction, audio containing speech from the customer and speech from the human agent (e.g., as separate audio channels or as a combined audio channel) may be processed by the speech recognition module 44 to identify words and phrases uttered by the customer and/or the agent during the interaction. In some embodiments of the present invention, a different speech recognition modules are used for the IMR and for performing voice analytics of the interactions (e.g., the speech recognition module may be configured differently for the IMR as compared to the voice interactions, due, or example, to differences in the range of different types of phrases expected to be spoken in the two different contexts).

In some embodiments, the routing server 20 may query a customer database, which stores information about existing clients, such as contact information, service level agreement (SLA) requirements, nature of previous customer contacts and actions taken by contact center to resolve any customer issues, and the like. The database may be, for example, Cassandra or any non-SQL database, and may be stored in a mass storage device 30. The database may also be a SQL database an may be managed by any database management system such as, for example, Oracle, IBM DB2, Microsoft SQL server, Microsoft Access, PostgreSQL, MySQL, FoxPro, and SQLite. The routing server 20 may query the customer information from the customer database via an ANI or any other information collected by the IMR server 34.

According to one exemplary embodiment of the invention, the mass storage device(s) 30 may store one or more databases relating to agent data (e.g. agent profiles, schedules, etc.), customer data (e.g. customer profiles), interaction data (e.g. details of each interaction with a customer, including reason for the interaction, disposition data, time on hold, handle time, etc.), and the like. According to one embodiment, some of the data (e.g. customer profile data) may be maintained in a customer relations management (CRM) database hosted in the mass storage device 30 or elsewhere. The mass storage device may take form of a hard disk or disk array as is conventional in the art.

### Quality Monitoring Automation

Aspects of embodiments of the present invention are directed to systems and methods for automating portions of a quality monitoring process in a contact center. The quality monitoring process may be used to monitor and evaluate the quality of agent interactions with customers who interact or communicate with the contact center. Aspects of embodiments of the present invention include, for example, performing automatic speech recognition on voice interactions, automatically detecting events and topics within interactions between human customers and human agents of a contact center, and automatically generating suggestions, guidance, and answers based on the detected events and topics. In many instances, topics that may be of interest to contact center managers (e.g., for identifying trends within the contact center) may also be of interest to the quality monitoring processes and therefore systems and methods for performing analytics on contact center interactions may be applied in the context of quality monitoring.

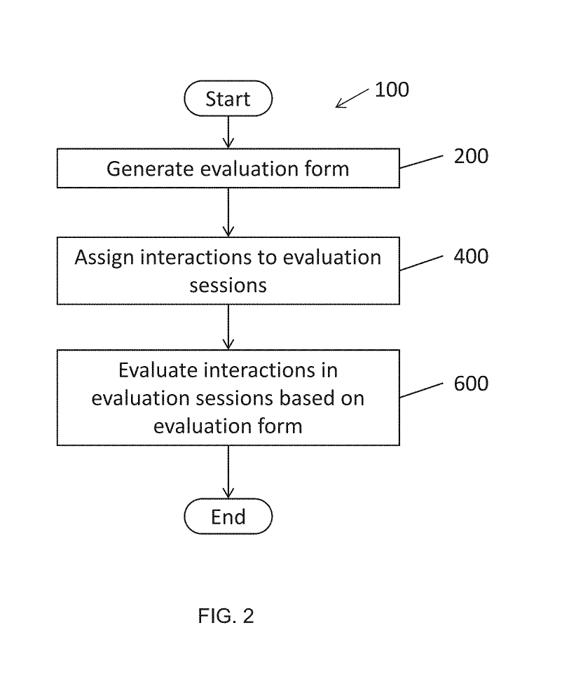

FIG. 2 is a flowchart illustrating a method 100 for quality monitoring. Broadly speaking, contact center quality monitoring in some embodiments of the present invention involves three stages: 1) generating an evaluation form 200; 2) assigning interactions to evaluation sessions and to evaluators 400; and 3) performing the evaluation sessions 600.

In the first stage 200, a form developer, such as a human manager associated with the quality monitoring process, creates or authors an evaluation form which an evaluator will use to evaluate an agent's performance during an interaction that the agent participated in. The evaluation form may include one or more questions such as “did the agent present himself?” and “was the agent attentive?” The form developer may also set the data types of the answers to the questions, e.g., whether the answers are: a yes/no data type (“yes” or “no”); a multiple response data type (a multiple choice question); numerical value data type (e.g., on a scale from 1 to 10); or free text data type (e.g., a free written response). In addition, portions of the evaluation form may automatically be presented or not presented (e.g., automatically hidden or shown) based on a condition. For example, if the particular interaction being evaluated included an “escalation request” (e.g., as identified by an evaluator or by the agent) the form may be automatically populated with the question “how did the agent handle the escalation request?”

In a next stage 400, evaluation sessions may be created and assigned to evaluators or quality monitoring analysts. The evaluators (or QM analysts) may be people who manually review interactions and evaluate the agents of those interactions by filling out an evaluation form created by the form developer. Interactions of interest are assigned to evaluation sessions by performing searches across interactions stored in the system to identify interactions that contain features that include issues or features of interest to the quality monitoring program (e.g., the managers of the agents). These interactions may include, for example, interactions containing profanity or to identify interactions in which the agent did not thank the customer for their business. These searches may be used to provide specific examples of agent behavior, and may also be used to assign particular types of calls to particular evaluation sessions based on a category or topic (e.g., interactions involving profanity), and these evaluation sessions may be assigned to various evaluators. In some embodiments, assignments of evaluation sessions to evaluators may be performed through random assignment, or based on an evaluator's particular skills or expertise (e.g., familiarity with particular product lines and command of particular languages such as English or Spanish).

In the following stage 600, the evaluators evaluate the interactions associated with the evaluation sessions that are assigned to them in the previous stage using the evaluation forms created by the form developer. Generally, evaluators are expected to review the entire interaction (e.g., listen to the entire recording or read the entire transcript) when performing their evaluations of the agents.

After the evaluation, the agent may be provided with the results of the evaluation. Particularly notable evaluations (e.g., agents demonstrating egregiously inappropriate behavior or superb performance) may be provided to a supervisor or compliance officer. High quality interactions may be saved into a training library as models, and interactions deemed relevant to a particular product team (e.g., illustrating customer problems with products) may be provided to that product team for review.

Aspects of embodiments of the present invention are directed to systems and methods for supporting a quality monitoring process in a contact center. Some aspects of embodiments of the present invention are directed to assisting the form developer in the creation or authoring of the evaluation form. Some aspects of embodiments of the present invention are directed to assisting in or automatically selecting interactions to be evaluated. Some aspects of embodiments of the present invention are directed to assisting an evaluator by automatically identifying one or more relevant portion of the interaction relevant to each question of the evaluation form (e.g., for a question “did the agent thank the customer for his or her business?” the system may automatically identify a portion of the interaction in which the agent said “I see you have been a customer for seven years. Thank you for your continued business.”). Some aspects of embodiments of the present invention are directed to automatically filling in answers to at least some portions of the evaluation form based on an automatic analysis of the interaction.

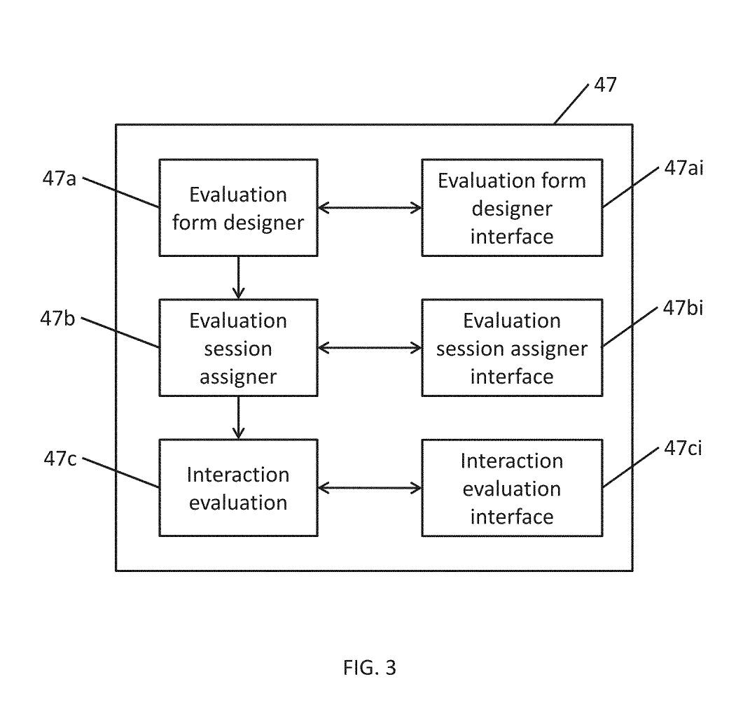

FIG. 3 is a block diagram illustrating a quality monitoring system 47 according to one embodiment of the present invention, where different components of the quality monitoring system 47 may assist in the performance of various portions of the quality monitoring method 100. In particular, the evaluation form designer 47a is configured to generate evaluation forms and to assist the form developer in authoring the evaluation forms, the evaluation session assigner 47b is configured to assign interactions to evaluation sessions and to assign the evaluation sessions to evaluators, and the interaction evaluation module 47c is configured to process an evaluation form based on an associated interaction and to assist an evaluator in evaluating the associated interaction.

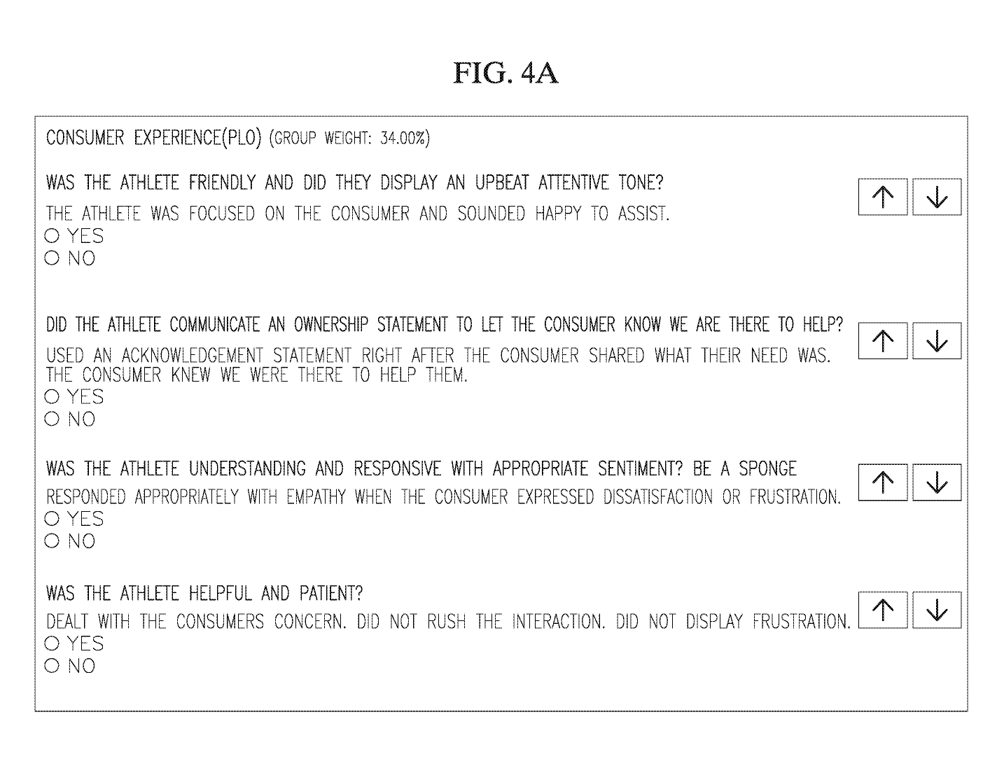

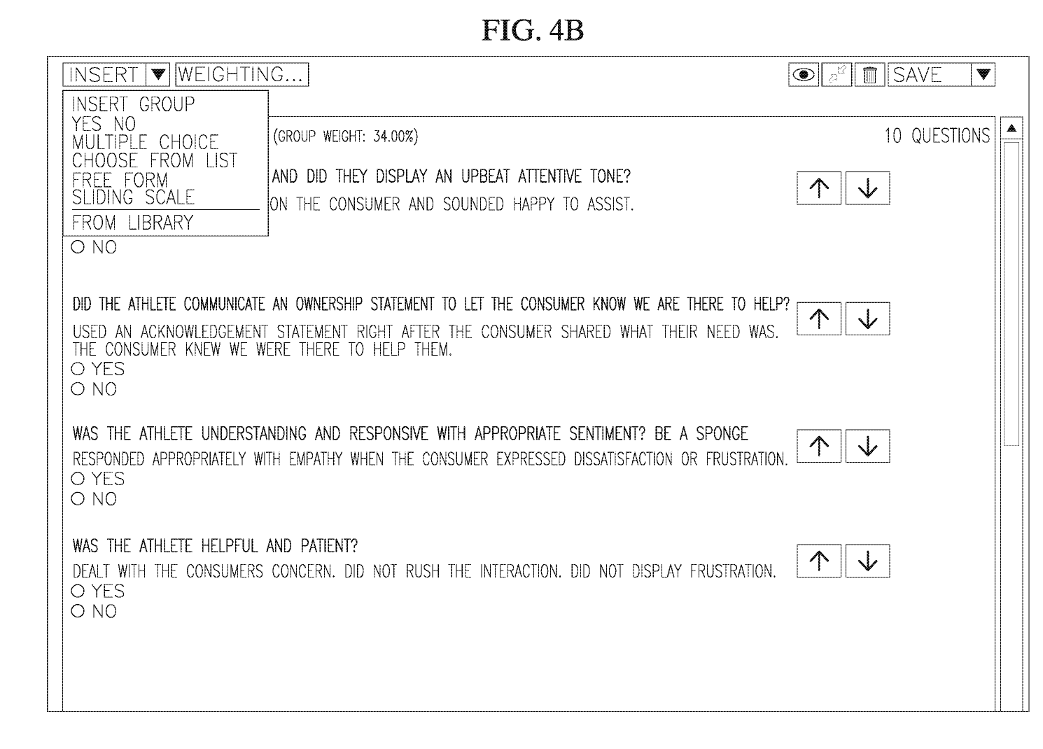

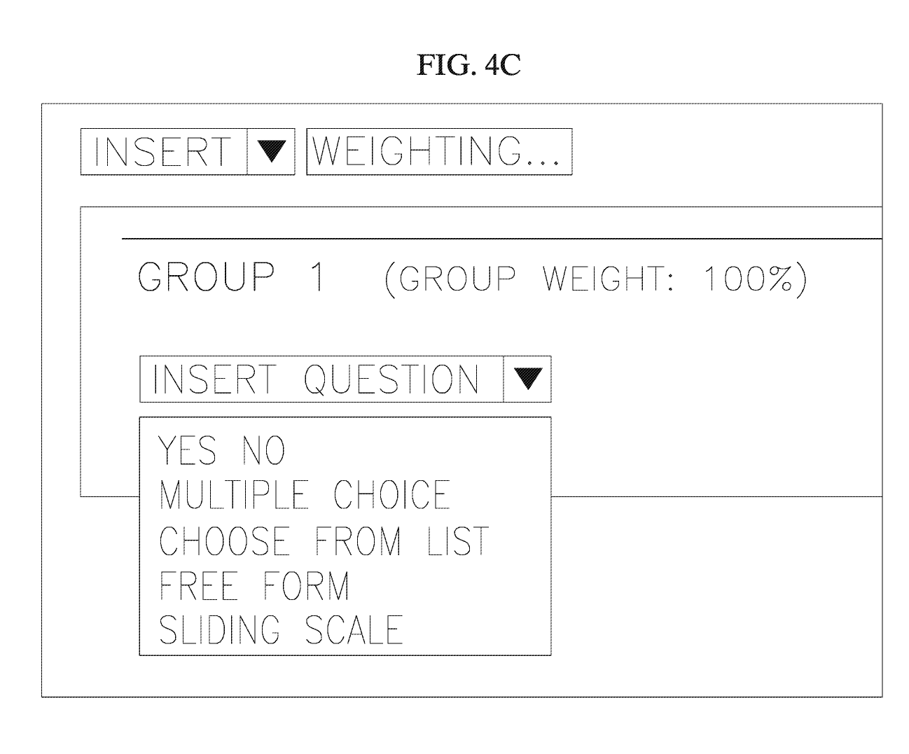

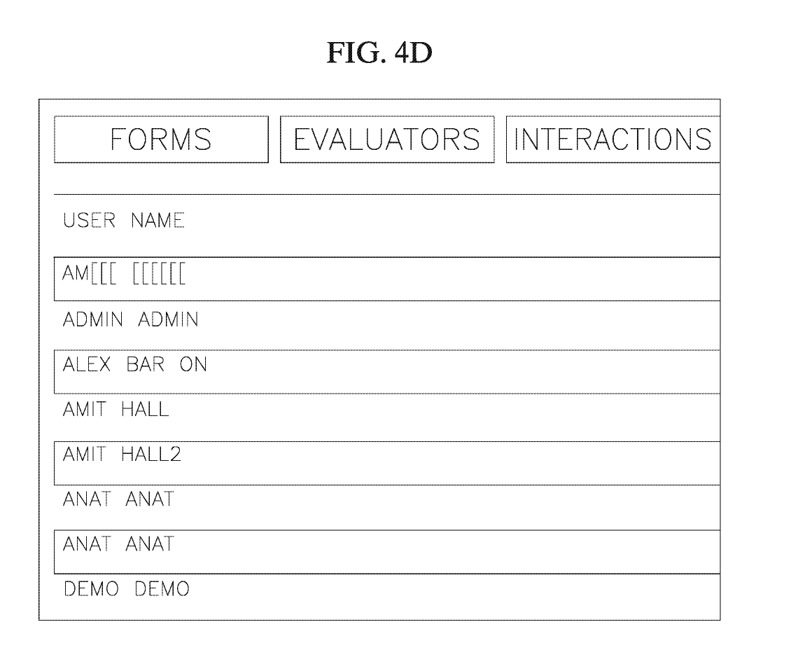

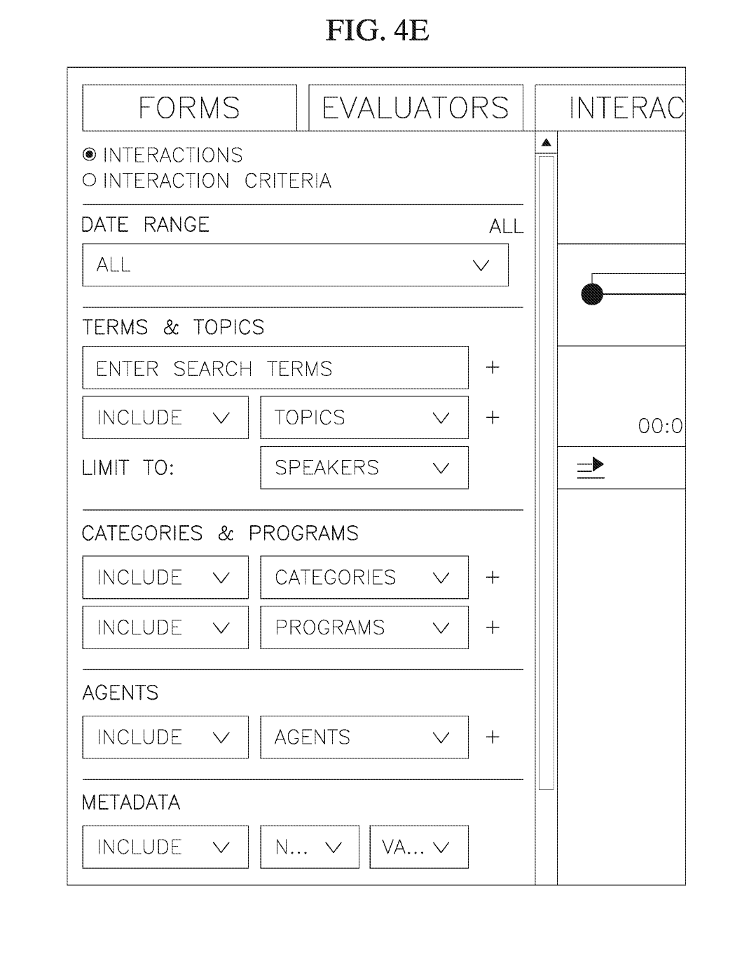

The evaluation form designer 47a is coupled to an evaluation form designer interface 47ai. The evaluation form designer interface 47ai may be configured to provide or support a user interface for an evaluation form developer to supply, for example, questions for an evaluation form, types of the questions in the form, answers to the questions, and topics associated with questions. FIG. 4A is a screenshot illustrating a user interface associated with the evaluation form designer interface 47ai according to one embodiment of the present invention, where the user interface shows a plurality of questions. The order of the questions changed. FIGS. 4B and 4C are screenshots illustrating a user interface associated with the evaluation form designer interface 47ai according to one embodiment of the present invention, where the user interface shows the addition of a new question to the evaluation form and the selection of a question type.

The evaluation form assigner 47b is coupled to an evaluation session assigner interface 47bi. The evaluation session assigner interface 47bi is configured to assign interactions to evaluation sessions and to assign the evaluation sessions to evaluators. FIG. 4D is a screenshot illustrating a user interface associated with the evaluation session assigner interface 47bi according to one embodiment of the present invention, where potential evaluators are listed. FIG. 4E is a screenshot illustrating a user interface for searching for interactions matching particular criteria, where the interactions matching the search criteria can be added to an evaluation session.

The interaction evaluation module 47c is coupled to an interaction evaluation interface 47ci. FIG. 4F is a screenshot illustrating a user interface for an interaction evaluation, where the screenshot shows a current question being answered and an indication (e.g., an arrow) of a particular portion of the interaction that has been automatically identified as likely to be relevant to answering the current question.

The quality monitoring system 47 may be implemented by one or more hardware devices including a processor and memory. Various portions of the quality monitoring system 47 may be implemented by the same hardware device or multiple hardware devices. For example, the evaluation form designer 47a, the evaluation session assigner 47b, and the interaction evaluation module 47c may be implemented on separate hardware devices or the same hardware device. Similarly, the corresponding interface modules 47ai, 47bi, and 47ci may be implemented using the same hardware device or separate hardware devices. In addition, multiple hardware devices may be operated in parallel to perform similar functions. For example, the interaction evaluation module 47c may be implemented on multiple hardware devices.

As described herein, some operations may be performed by multiple different computers. For example, in embodiments of the present invention which are hosted on a network and in which a user controls the system via a client device in communication with a server device, the identification of particular portions of an interaction may be performed on the server or on the client. In other embodiments of the present invention, the operations may be performed entirely on one hardware device, such as the client.

The interfaces 47ai, 47bi, and 47ci may be implemented in a number of ways and provide a conduit or a portion of a conduit by which users (humans) may interact with various portions of the quality monitoring system 47. In various embodiments of the present invention, the interfaces 47ai, 47bi, and 47ci may include or be one or more of: a graphical user interface running on a hardware device local to the user (e.g., a user's personal laptop); a web server supplying static HTML documents to a web browser running on a client; a web server configured to supply static documents and supplying a web based application programming interface (API) to interact with an application running in a web browser (e.g., using asynchronous JavaScript and XML, also known as AJAX); and a network connected server running an API that is configured to interact with a “thick” local client running natively on a client computer.

Broadly, a “topic” refers to a concept or event that occurred in an interaction. A topic may be constructed from one or more phrases and interactions that contain those phrases can be identified as relating to that topic. For example, a topic called “delinquency” may include the phrases: “delinquent balance,” “past due,” “delinquency notice,” and “set up payment arrangement.” Detecting any of the phrases within an interaction (e.g., within a speech-to-text transcript of a voice interaction or based on matching the text within the transcript of a text-based chat session) can identify the section containing the phrases as relating to the associated topic. Topics can be grouped together into “meta topics” and meta topics may be grouped with other meta topics and/or topics to form a semantic hierarchy or taxonomy of meta topics and topics.

Additional detail regarding analytics systems and methods for automatically detecting and tracking topics can be found, for example, in: U.S. patent application Ser. No. 13/952,459 “System and Method for Discovering and Exploring Concepts,” filed in the United States Patent and Trademark Office on Jul. 26, 2013; U.S. patent application Ser. No. 14/327,476 “System and Method for Semantically Exploring Concepts,” filed in the United States Patent and Trademark Office on Jul. 9, 2014; and U.S. patent application Ser. No. 14/586,730 “System and Method for Interactive Multi-Resolution Topic Detection and Tracking,” filed in the United States Patent and Trademark Office on Dec. 30, 2014, the entire disclosures of which are incorporated by reference herein.

Systems and methods for assisting, through the use of analytics, form developers, managers, and evaluators in a quality monitoring process of a contact center will be described in more detail below.

Designing a Form

When a form developer creates or edits an evaluation form via the evaluation form designer interface 47ai, topics and meta topics identified by an analytics system 45 (e.g., manually defined or automatically identified topics and meta topics) can be suggested to the form developer via the evaluation form designer interface 47ai. For example, if the analytics system 45 typically detects a topic such as “agent profanity” (e.g., an interaction containing one or more agent phrases corresponding to obscene language), then, when the form developer supplies a new question for the evaluation form such as: “Did the agent use profanity?” to the evaluation form designer 47a, the evaluation form designer 48a may suggest the “agent profanity” topic as one that may be relevant to the question. Other examples of topics include “assume ownership” (where the agent verbally assumes ownership of the problem and its solution for the customer).

The evaluation form designer 47a may also be used to determine the relevance of questions authored by a form developer. For example, the form developer may input a question such as “did the customer threaten legal action?” as a question for the evaluation form. The evaluation form designer 47a may then query the analytics system 45 to determine a number (or a percentage) of interactions that include the topic “threaten legal action.” If that number is very small (e.g., below a threshold value), then the evaluation form designer 47a may provide an indication to the form developer, via the evaluation form designer interface 47ai, that the question would be relevant only to a small number of interactions and therefore will be irrelevant to most evaluation sessions and potentially unnecessarily burdensome to answer. (Relevance to only a small number of interactions may refer, for example, to very few interactions being tagged with a particular topic, or substantially all interactions being tagged with the topic, where in both situations, the answer to the question would substantially always be the same.) On the other hand, if the question is relevant to a large number of interactions (e.g., but not all interactions), then the form designer interface 47ai may provide an indication that this is a good question.

In addition, the evaluation form designer 47a may suggest adding questions that relate to topics that correlate with other topics. For example, if a certain topic is correlated with a “customer dissatisfied” topic, then a question may be added regarding this topic in the evaluation form. The information regarding correlation of topics may be provided by the analytics system 45, which tracks the appearance of topics in various interactions of the contact center.

In some embodiments of the present invention, relationships between questions of the evaluation form are manually specified by the form developer via the evaluation form designer interface 47ai. In some embodiments of the present invention, machine learning techniques are used to automatically infer relationships between the text of a question supplied by the form developer and defined topics that are currently tracked by the analytics system 45 and these automatically inferred topics are suggested to the form developer via the evaluation user form designer interface 47ai. In some embodiments of the present invention, relationships are automatically inferred by comparing the text of a question supplied by the form developer to clusters of phrases automatically detected by the analytics system 45.

Manual Connections Between Quality Monitoring and Analytics

In some aspects of embodiments of the present invention, a form designer manually makes connections between topics and questions, at the time that the evaluation form developer creates the evaluation form in operation 200, the evaluation form developer uses the evaluation form designer interface 47ai to add a question to the evaluation form and to manually associate the question with an existing topic. The evaluation form designer interface 47ai may display a list of topics tracked by the analytics system 45 that the evaluation form developer can choose from and the connection between the question and the topic is made based on the evaluation form developer's manual selection of the topic, where the connection is made by updating a database or appropriate data structure to add the topic to a collection of topics associated with the question.

For example, for a question such as: “Did the agent take ownership of the problem?,” the evaluation form developer may manually select the topic “Assume Ownership” from the list of topics tracked by the analytics system 45 (where an interaction tagged with the “Assume Ownership” topic indicates that the agent spoke one of the phrases contained in the “Assume Ownership” topic, such as “I can solve your problem,” or “I can take care of that for you”). The selected topic can then be associated with the question (e.g., by storing, in a database of evaluation forms, the topic as one of the question topics associated with the question).

As such, when an interaction is being evaluated in operation 600, if the topic associated with a question is found in the interaction, then the detection of the topic in the interaction is used to indicate the portions of the interaction that relate to the topic, such that the evaluator can review those portions more carefully when answering the question. In addition, in some embodiments of the present invention, the question may be automatically answered in accordance with the presence of the topic. These aspects will be described in more detail below.

Automatic Connections to Topics

Some aspects of embodiments of the present invention relate to automatically inferring relationships between questions authored by the evaluation form developer and the topics tracked by the analytics system 45. In some embodiments of the present invention, machine learning techniques such as semantic similarity (see, e.g., U.S. patent application Ser. No. 13/952,459 “System and Method for Discovering and Exploring Concepts,” filed in the United States Patent and Trademark Office on Jul. 26, 2013 and U.S. patent application Ser. No. 14/327,476 “System and Method for Semantically Exploring Concepts,” filed in the United States Patent and Trademark Office on Jul. 9, 2014, the entire disclosures of which are incorporated by reference herein) may be used in the process of inferring topics based on the text of the questions.

For example, the evaluation form developer may create a new question with the text: “Did the agent establish the customer's need early on in the interaction by asking ‘how can I assist’ and by clarifying the customer's query? E.g., booking a flight, existing flight, cancelation, ongoing reservation, etc.” The question can be supplied to the evaluation form designer 47a via the evaluation form designer interface 47ai.

The evaluation form designer 47a analyzes the text of the question supplied by the evaluation form developer and automatically identifies the semantic similarity between the question and existing topics tracked by the analytics system 45 to identify one or more tracked topics that are similar to the question. For example, the analytics system 45 may include a “Greeting” topic, which includes the phrases: “how can I help you,” “how can I help you today,” “how may I help you,” and “how may I help you today.” The semantic similarity between the words “how can I assist” in the question and the “Greeting” topic may be determined even when the word “assist” does not appear in any of the phrases in the “Greeting” topic, through the use of semantic similarity (see Mikolov, Tomas, et al. “Distributed representations of words and phrases and their compositionality.” Advances in neural information processing systems. 2013).

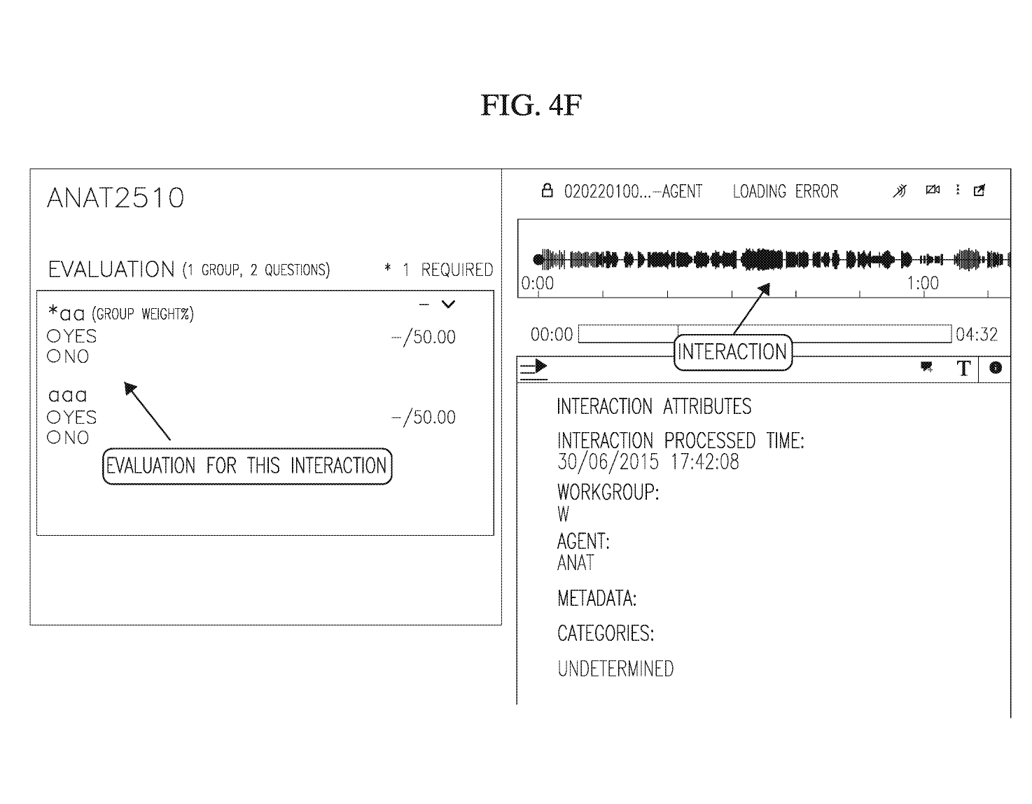

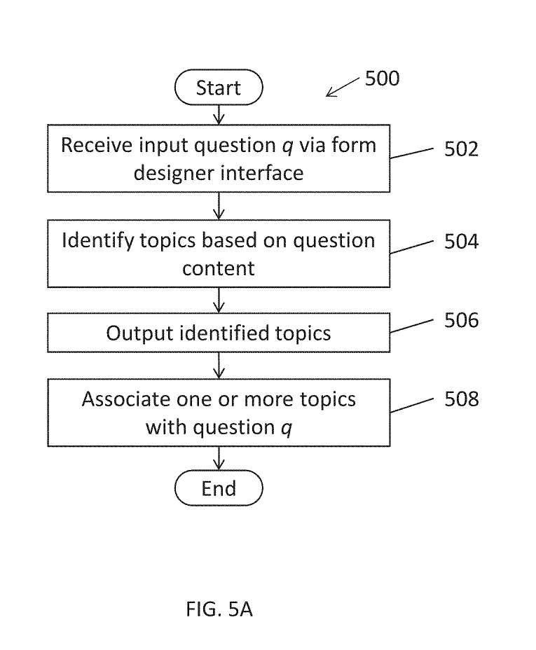

FIG. 5A is a flowchart illustrating a method 500 for generating suggestions for a form developer in a form designer interface 47ai according to one embodiment of the present invention. Referring to FIG. 5A, in operation 502, the form designer interface 47ai may receive an input question q from a form developer as a question to be added to an evaluation form that is currently being developed. (In some embodiments of the present invention, input question q may also represent an edited version of an existing question in the evaluation form.) The question q may be represented, for example, as plain text. In operation 504, a set of tracked topics (e.g., topics already tracked by the analytics) that are similar to the supplied question q are automatically identified based on similarity between the question q and the tracked topics. One technique for identifying such topics is described in more detail below with reference to FIG. 5B. In operation 506, the identified ones of the tracked topics are output (e.g., displayed to the form developer via the form designer interface 47ai). In operation 508, the one or more identified topics are associated with the question q and these identified topics may be referred to as the question topics of question q.

To identify tracked topics that are relevant to the questions, in one embodiment of the present invention, each question and each tracked topic (or each phrase contained in the topic) is represented using a corresponding word vector. For each possible pairing of questions and tracked topics (e.g., where the number of pairings is the number of questions times the number of topics), for each unique word in the question, a most similar word of the topic (e.g., in one embodiment, each topic includes a set of phrases, each phrase including one or more words, so a most similar word from among the words of the phrases) is identified (e.g., identified with a numerical similarity score). The similarity between the current question and the current one of the tracked topics is then the sum of the similarities of the individual words of the question to the topic. If the resulting sum exceeds a threshold value, then it is inferred that there is a connection between the question and the topic. FIG. 5B is a flowchart illustrating the computation of whether or not to make a connection between a question q and a topic t according to one embodiment of the present invention. Table 1, below, is a pseudocode description of a method for determining whether or not to make a connection between a questions and topics.

TABLE 1
Connecting questions to topics

For every (topic t, question q) pair

Sim(q, t) = 0
For every unique stemmed word u in q

For every unique stemmed word v in t

S = similarity(u, v)
Sₘₐₓ(u) = max(S, Sₘₐₓ(u))

Sim(q, t += Sₘₐₓ(u)

| | |
|---|---|
| Sim(q, t) /= \|q\| | // \|q\| is the number of unique stemmed |

words in q

If Sim(q,t) > Threshold

Connect q and t

Referring to FIG. 5B, according to one embodiment of the present invention, a method 550 may be used to determine whether or not to make a connection between a given question q and a given topic t. In operation 552, an question-topic similarity metric between the question q and the topic t Sim(q, t) is initialized (e.g., initialized to zero). Operation 554 corresponds to the beginning of a loop iterating over the unique stemmed words in q (e.g., a first unique word u is selected from the question q). Similarly, operation 556 corresponds to the beginning of a loop iterating over the unique stemmed words v in topic t. As used herein, a “stemming” refers to converting a given word to its stemmed root form (such as reducing the words “helping,” “helper,” and “helped” to their common root “help”). In operation 558 a similarity metric S is computed between the words u and v. This similarity metric may be computed based on whether, for example, whether the words are the same or have similar meaning (e.g., based on techniques such as dictionaries for determining the semantic similarity of words). In operation 560, a current maximum similarity metric Sₘₐₓ(u) for the word u of the question q is updated to store the maximum similarity metric found so far (Sₘₐₓ(u) may initially be set to 0). In operation 562, the evaluation form designer 47a determines whether there are more words in the topic t. If so, then flow continues to operation 556, where the next word in t is selected and set as current word v. If there are no additional words in topic t, then in operation 564 the question-topic similarity metric S is updated to add the calculated maximum similarity metric for the current word u of the question q. In operation 566, the evaluation form designer 47a determines whether there are more words in the question q. If so, then flow continues to operation 554, where the next word in q is selected and set as current word u. If not, then the flow proceeds to operation 568, where the computed similarity metric S is normalized by the number of unique words in q. The normalized similarity metric S is compared to a threshold value (to determine whether the question q is similar to the topic t. If so, then, in operation 570, the question is connected to the topic (e.g., by updating a database or an appropriate data structure to include the topic as one of the topics associated with the current question).

Embodiments of the present invention are not limited to the above and alternative techniques for computing similarities between questions and topics may be used (e.g., alternative techniques for comparing collections of words).

In some embodiments of the present invention, each word is weighted by its saliency, e.g., by its inverse document frequency (IDF), thereby giving more weight to words that are more significant (e.g., “help”) and giving less weight to unimportant words (e.g., “the”, “and”, “I”). In some embodiments of the present invention, the similarity metric can be computed between sequences of words or “n-grams” (e.g., noun phrases of the question and noun phrases of the topic) rather than individual words.

As noted above, in some analytics systems, a topic is defined as the union of the phrases that it contains and, in some embodiments, may also include the name of the topic itself. For example, in some embodiments, the above discussed “Greeting” topic includes the phrase “greeting” among its phrases. As such, the question “did the agent greet the customer” would also have a high similarity metric to the topic “Greeting” due to the high similarity metric with the phrase “greeting.”

In some embodiments of the present invention, the analytics system 45 also organizes the topics into a hierarchy or taxonomy of topics. In particular, topics can be grouped together into meta topics, as illustrated, for example, in Table 2 below:

TABLE 2
“Billing” meta topic example

| Meta topic | Topic | phrase |
|---|---|---|
| billing | already paid | we paid the balance in full |
| billing | already paid | when we ordered it we sent a check in |
| billing | balance inquiry | account balance is |
| billing | balance inquiry | amount in the stock |

As seen in Table 2, above, the “already paid” topic includes the phrases “we paid the balance in full” and “when we ordered it we sent a check in”. The “balance inquiry” topic includes the phrases “account balance is” and “amount in the stock.” Both of these topics generally relate to “billing” and therefore are grouped into the “billing” meta topic. When matching questions to a hierarchy or taxonomy of topics and meta topics, the name of the meta-topic may also be included in the list of unique words of the topic, so that a relevant portion of the interaction can be suggested for a question containing the word “bill,” even if the underlying phrases themselves do not include the word “bill.”

As such, questions can be automatically associated with topics tracked by the analytics system 45 by identifying topics that are similar to the text of the question.

Some aspects of embodiments of the present invention may also be associated with associating the answers to multiple choice questions with particular topics. For example, in a manner similar to comparing the text of the question to the various topics, the answers of a multiple choice question can be compared, in conjunction with the question text, to the topics in order to identify which topics distinguish those answers from the other answers. In other words, because both the question and the answer correlate in the interaction document, each answer is unified with the question to form a separate question and answer combination, and the resulting combination is compared to the topics to identify a most similar topic.

Automatic Connections to Clusters

In some embodiments of the present invention, questions are connected to clusters of phrases (or “exploration clusters”) that were automatically identified by the analytics engine 45. Systems and methods for the exploration of topics and automatic identification of clusters are described in, for example, U.S. patent application Ser. No. 13/952,459 “System and Method for Discovering and Exploring Concepts,” filed in the United States Patent and Trademark Office on Jul. 26, 2013, the entire disclosure of which is incorporated by reference, which generally describes the mining of transcripts of interactions to identify salient phrases and clustering the phrases based on similarity to identify clusters of phrases that, in some instances, are not tracked by previously defined topics.

In a manner similar to that described above with respect to the connection of questions to topics, the text of the questions and, in some cases, the multiple choice answers, can be compared with the phrases contained in the clusters using the similarity heuristic Sim. Because each cluster is represented with a cluster name or label and a corresponding set of phrases or fragments, the process of connecting questions to clusters may proceed along the same lines as described above with respect to the connection to topics. In addition, as described above, sequences of words (or “n-grams”) may be used.

Automatically Recommending Interactions to be Evaluated

Aspects of embodiments of the present invention are also directed to systems and methods for automatically identifying interactions and for automatically assigning the identified interactions to evaluation sessions for evaluation.

In one aspect, embodiments of the present invention may automatically identify interactions relating to specific issues that the quality monitoring manager (e.g., the form developer) may want to measure in the contact center.

According to another aspect of embodiments of the present invention, learning opportunities can be presented to particular agents by identifying interactions in which the agent could have performed better. For example, the analytics system 45 may automatically analyze interactions for sentiment information (e.g., whether the customer ended the interaction with a positive or negative sentiment). As such, embodiments of the present invention may automatically identify interactions that ended with a negative sentiment for further evaluation by an evaluator. As another example, agents who fail to take ownership of the customer's problem on a regular may be presented with examples of interactions in which the agent failed to do so.

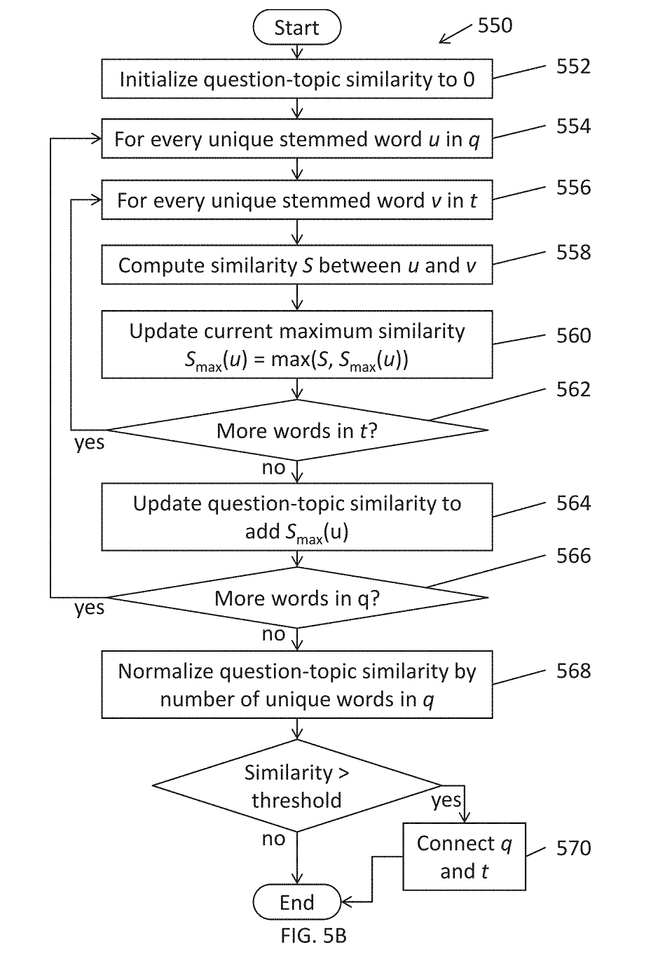

FIG. 6 is a flowchart illustrating a method 600 for assigning interactions to an evaluation session according to one embodiment of the present invention. Broadly speaking a manager may choose to identify particular types of interactions to a particular evaluation session based on seeking to evaluate the interactions for particular features (e.g., interactions relating to particular subject matter such as a new product offering). In operation 602, the evaluation assigner interface 47bi receives interaction filtering criteria, such as topics of interest, agent names, agent skills, and date ranges. In operation 604, the interactions from a collection (e.g., stored in the multimedia/social media server 24, the call recording storage 42, the voice analytics system 45, recognized text storage 46) are filtered for those that satisfy (e.g., match) the filtering criteria. In operation 604, those interactions are supplied to the evaluation assigner interface 47bi for display to the manager. In some embodiments, the manager may then choose to modify the set of interactions (e.g., by adding additional interactions matching different criteria or by further filtering the interactions based on additional criteria) using the evaluation assigner interface 47bi. In operation 606, the identified interactions satisfying the criteria are then associated with one or more evaluations. For example, the interactions may be all assigned to a same evaluation session or divided (e.g., randomly) among multiple evaluation sessions. In operation 608, the evaluation session (or sessions) is assigned to an evaluator (or evaluators) who evaluate the interactions in the evaluation session based on an evaluation form such as an evaluation form generated by the evaluation form designer 47a described above. The assigned evaluator may be chosen based on criteria, such as expertise in a particular field (e.g., knowledge of a product line), particular skills (e.g., knowledge of Spanish or Chinese), or expertise in evaluating particular situations (e.g., understanding particular cultural mores and social cues).

Performing the Evaluations

Aspects of embodiments of the present invention provide different ways to assist in performing the evaluations of interactions. According to one aspect, as the evaluator evaluates an interaction by proceeding through the evaluation form generated by the form author, portions of the interaction that are relevant to answering the current question are automatically identified and suggested to the evaluator (e.g., by highlighting the relevant portion of a recording such as an audio recording or transcript thereof, by showing a popup containing the relevant portion and surrounding text, by automatically seeking a recording of the interaction to or near the relevant portion, or by automatically playing the relevant portion of the recording of the interaction). Depending on the nature of the question, embodiments of the present invention may automatically provide suggested answers to the question or may provide suggestions of locations that may have information relevant to the question.

As one example, embodiments of the present invention may provide a suggested answer to a question such as: “did the agent use inappropriate language during the interaction?” In such a circumstance, portions of the interaction that contain detected instances of inappropriate language (e.g., as detected by an automatic speech recognition system) may be automatically presented to the evaluator for the evaluator to as evidence that inappropriate language was used and the evaluator can answer the question accordingly. (The evaluator may also use his or her judgment in determining whether the identified portion of the interaction was a genuine instance of inappropriate language. For example, the speech may have been misclassified and actually may have been spoken by the caller or may have been a speech recognition error where a different word was actually spoken.)

On the other hand, a question such as “did the agent treat the customer nicely?” require some more subjective analysis and embodiments of the present invention may not be able to identify a portion of the interaction that directly answers the question. Nevertheless, embodiments of the present invention may still identify portions of the interaction that provide evidence of nice behavior or rude behavior, such as detecting the phrase “have a nice day” or “thank you for your patience.” These portions of the interaction may be automatically identified so that an evaluator can determine whether the agent actually treated the customer nicely (e.g., whether the phrases were said with a sincere or sarcastic tone of voice).

Automatically Suggesting Portions of Interactions Containing Answers

According to one embodiment of the present invention, suggestions of portions of the interaction containing evidence of answers to evaluation questions can be identified with the help of an analytics system 45. Generally, an analytics system 45 for a contact center automatically analyzes interactions between customers and agents, where these interactions are, for example, voice calls, emails, and chat sessions. In many instances, there is a large overlap between the data of interest to users of analytics systems and users of quality monitoring systems, and therefore analytics systems may be used to generate data that is of interest to managers who are interested quality monitoring of agents in a contact center and may be used to generate suggestions to answers to questions.

As mentioned above, examples of appropriate analytics systems include those described in, for example: U.S. patent application Ser. No. 13/952,459 “System and Method for Discovering and Exploring Concepts,” filed in the United States Patent and Trademark Office on Jul. 26, 2013; U.S. patent application Ser. No. 14/327,476 “System and Method for Semantically Exploring Concepts,” filed in the United States Patent and Trademark Office on Jul. 9, 2014; and U.S. patent application Ser. No. 14/586,730 “System and Method for Interactive Multi-Resolution Topic Detection and Tracking,” filed in the United States Patent and Trademark Office on Dec. 30, 2014, the entire disclosures of which are incorporated by reference herein.

As such, according to one embodiment of the present invention, an interaction evaluation module may provide an evaluator with suggestions or indications of portions of the interaction that are relevant to answering the questions in the evaluation form.

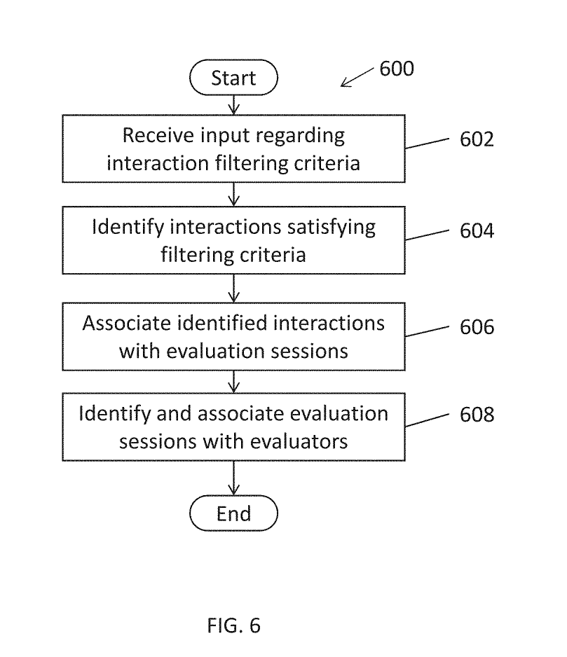

FIG. 7 is a flowchart illustrating a method 700 for providing suggestions of portions of an interaction containing an answer to a question according to one embodiment of the present invention. In operation 702, a current evaluation form and an interaction (or a representation or a portion thereof) are selected and displayed by the interaction evaluation module 47c to an evaluator through the interaction evaluation interface 47ci. A current question of the evaluation form may be selected (e.g., the question that the evaluator is currently trying to answer) and may be highlighted in a user interface used by the evaluator. In operation 704, the system loops or iterates over the questions in the form, selecting one current question q at a time for the evaluator to answer. In some embodiments, the evaluator may manually select a question to answer or an order in which to answer the questions or may choose to change the answer to an already answered question. In operation 706, one or more portions of the interaction that are relevant to the current question are automatically identified, as described in more detail below. In operation 708, the identified one or more portions are displayed (e.g., indications of the locations of the identified portions are provided to the interaction evaluation interface 47ci). An evaluator may use the identified portions to assist in answering the current question q, as described above (e.g., confirming that the agent used inappropriate language or that the agent expressly assumed ownership of the customer's issue). In operation 710, the interaction evaluation module 47c receives an answer to the question (e.g., an answer provided by the evaluator via the interaction evaluation interface 47ci). In operation 712, the interaction evaluation module 47c determines whether there are additional unanswered questions. If so, then the flow proceeds to operation 704, where a next unanswered question is selected. If not, then the process can end.

To identify portions of the interaction that are relevant to the current question q in operation 706, a plurality of topics that were associated with question q are retrieved from memory (e.g., the topics that were identified when the form was designed and in which topics were assigned to the question). The analytics data associated with the current interaction is compared with the topics associated with the question q to identify locations at which each of the topics associated with question q appear in the interaction (if at all). The locations of the topics of question q within the current interaction correspond to the portions of the interaction that may be relevant to answering the question q.

A user interface such as that shown in FIG. 4F may present identified portions of the interaction such that the evaluator can easily review the indicated portions of the interaction for evidence to answer the question q. As shown in FIG. 4F, a relevant portion of the interaction may be identified with an icon (such as an arrow) and selecting the icon may initiate playback of a portion of the recorded voice interaction corresponding to the identified portion (and, in some embodiments, additional portions of the recorded interaction immediately before and after the identified portion). In some embodiments, the relevant portion of the recorded voice interaction may be highlighted (e.g., in a different color or with a different shading) and selecting the highlighted portion may cause playback of that portion. As another example, relevant portions of a transcript of a chat session or an email interaction can be automatically highlighted or may “pop out” for the evaluator to review. As the evaluator proceeds through the evaluation form and answers different questions on the form, different portions of the interaction may be highlighted or identified as providing evidence for answering the current question.

As one example of a technique by which an analytics system can provide suggestions, the evaluation form may include a yes or no question such as: “Did the agent communicate an ownership statement to let the consumer know that we are there to help?”

If the analytics system 45 is configured to detect or track a topic such as “Assume Ownership,” then the analytics system may have detected this topic within the various interactions between customers and agents of the contact center, and therefore may have automatically tagged those interactions with this topic. The tag may include information such as the location or locations (e.g., time range or time ranges) of phrases corresponding to the “Assume Ownership” topic within the interaction.

As such, the interaction evaluation module 47c of the quality monitoring module 47 may automatically present, via the interaction evaluation user interface 47ci, an indication of a particular portion or particular portions of the interaction currently being evaluated as providing the answer to the question. In this case, using the locations of the portions of the interaction associated with the “Assume Ownership” topic to show that the agent did communicate an ownership statement to the customer.

Another example of a yes-or-no question on an evaluation form is “Did the agent focus on and communicate what could be done for the consumer as opposed to stating what cannot be done? In other words, did the agent avoid negative words such as ‘I can't’ and ‘unfortunately’?

To answer this question automatically using the analytics system, a topic corresponding to negative positioning may be created to capture negative phrases from an agent (e.g., “I can't,” “unfortunately,” “we don't,” and “policy does not allow”). Similarly, a topic corresponding to positive positioning can be created to capture positive phrases (e.g., “what we can do for you is . . . ,” “I can solve your problem,” and “I can help you with that”). Detecting the presence of positive phrases and the absence of negative phrases and presenting the locations of these phrases to an evaluator can assist the evaluator in answering this question having a “yes” or “no” answer.

A similar approach can be used for free response or free text questions that expect a text response. An example of such a question may be “provide an example of an exchange in which the agent framed an answer in an inappropriate manner, such as blaming the customer” and another example may be “suggest an alternative to the agent's inappropriate response at this stage of the interaction.” Under this example, the interaction evaluation module 47c may automatically identify portions of the interaction associated with inappropriate behavior (e.g., an “Agent Inappropriate” topic) for the evaluator to review when answering this question.

In the case of multiple choice questions of the evaluation form, embodiments of the present invention may use the topics associated with the question-answer combinations to determine which answer may be most relevant to the multiple choice question. For example, if a question q has answers a₁, a₂, and a₃, then a first question-answer combination q ∘ a₁ may be associated with a first set of topics, a second question-answer combination q ∘ a₂ may be associated with a second set of topics, and a third question-answer combination q ∘ a₃ may be associated with a third set of topics. The interaction evaluation module 47c may suggest portions of the interaction that provide evidence as to whether the answer to the question is a₁, a₂, or a₃ based on locations in the interaction containing the first set of topics, the second set of topics, or the third set of topics.

More formally, given s as the string for which we check evidence of in the interaction, t as a topic, and d as the interaction document (e.g., transcript of the voice conversation, text chat, or email), the likelihood P(s|d) of having string s appear in document d is given by:

$$P ( s \vert d ) = {\sum }_{t} P ( s \vert t , d ) P ( t \vert d )$$

where P(s|t, d) is the likelihood of having s given that topic t appears in the document d, and P(t|d) is the prior of t appearing in d.

A similarity heuristic Sim may be defined as:

$$Sim ( s , d ) = {\sum }_{t} Sim ( s , t ) w ( t )$$

In the above similarity heuristic Sim, the similarity of string s to d is computed by partitioning on the topics appearing in interaction document d. The similarity of s to t in d is multiplied by the prior weight of t in d by w(t), where w(t) can be defined as the number of detections of topic t in interaction document d divided by the total number of topic detections in interaction document d.

To check the match of both question q and answer a the string s to match is defined as:

s=q∘a

where ∘ is the concatenation operator, and the final decision as to which of the answers applies is made by:

i*=ArgMaxᵢ Sim(sᵢ,d)

where

sᵢ=q∘aᵢ

To identify a suggested portion of the interaction, the interaction evaluation module 47c identifies portions corresponding to the topics associated with each question and answer combination q ∘ aᵢ*. These identified portions can be provided to the evaluator to assist in determining which of the answers a applies to the interaction currently being evaluated.

As such, embodiments of the present invention can assist an evaluator in completing an evaluation form to evaluate an interaction by automatically identifying portions of the interaction that are relevant to the question currently being answered.

Automatically Answering Questions Based on Information in Historical Interactions

According to some aspects of embodiments of the present invention, answers to questions in the evaluation form can be automatically answered by analyzing the interaction based on a model developed from a historical questions and answers knowledge base (KB).

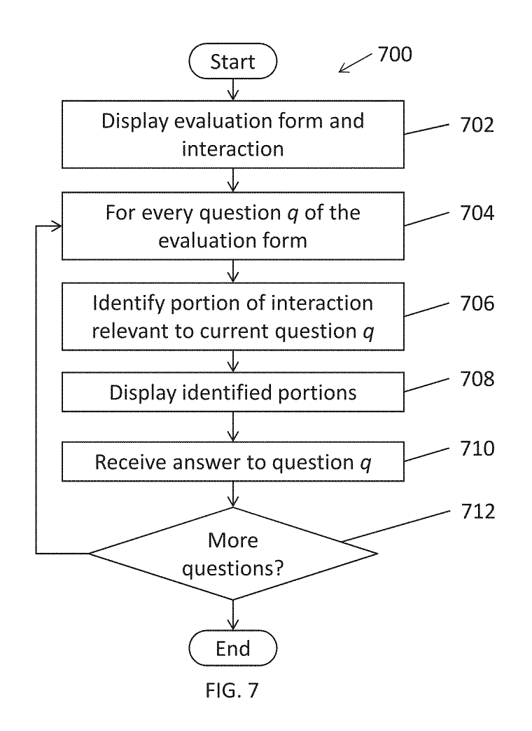

FIG. 8 is a flowchart illustrating a method for training a Knowledge Base according to one embodiment of the present invention.

According to one embodiment of the present invention, the knowledge base (KB) is formalized as a set of triples:

KB={(q, a, i_{d})}

where q is a question, a is an answer, and i_{d} is an interaction document in context, representing the content of the corresponding interaction (e.g., a voice call, a text chat, or an email thread) in which question q was answered with answer a. Referring to FIG. 8, in operation 802, triples d of question q, answer a, and interaction document i_{d} are generated from evaluations of previously evaluated interactions. For example, a set of previously evaluated interactions may have been evaluated with evaluation forms that include the question: “did the agent use a curse word?” The answers to the question for each of the previously evaluated interaction can be used to generate a set of triples that include the question (“did the agent use a curse word?”), the “yes” or “no” answer to the question, and the interaction itself (e.g., a transcript of the interaction).

Because questions and answers can be formed in many ways, and because the interaction content itself can phrase similar concepts in a wide range of ways, some embodiments of the present invention use a flexible matching tool. Methods for parsing data for questions and answers are described, for example, in Berant, Jonathan, Chou, Andrew, Frostig, Roy, and Liang, Percy. Semantic parsing on freebase from question-answer pairs. EMNLP, 2013 pp. 1533-1544. However, these methods generally require high quality or “clean” data. Interaction data collected in the context of contact centers is generally noisy due to, for example, errors in an automatic speech recognition process performed by the speech recognition module 44 and typographical errors in the text chat or email conversations between customers and agents.

In related work, matching functions are obtained using an information retrieval (IR) approach and by building a text index. While a simple Frequently Asked Questions (FAQ) lookups using an IR system looks for the closest question in the KB and suggesting its assigned answer, embodiments of the present invention also employ the interaction content as the context for the question because the answer will change depending on the interaction content.

As such, in embodiments of the present invention that use the information retrieval approach, the KB is modeled in a word-document vector space model (VSM) in which each document (e.g., each interaction) is represented as a term frequency-inverse document frequency (TF-IDF) vector. The model is a bag of words (BoW) model. Each of the triples (q, a, i_{d}) in the KB is looped over in operations 804 and 808 and indexed, in operation 806, in a text index I (e.g., an index generated by the open source Apache Lucene information retrieval library) for the question q, answer a, and interaction document i_{d}.

Because a vector space model is used, there is a notion of similarity between the triples. One example of a similarity is the cosine similarity between the vectors. When the vectors contain multiple fields, each one is taken with a corresponding weight of the field.

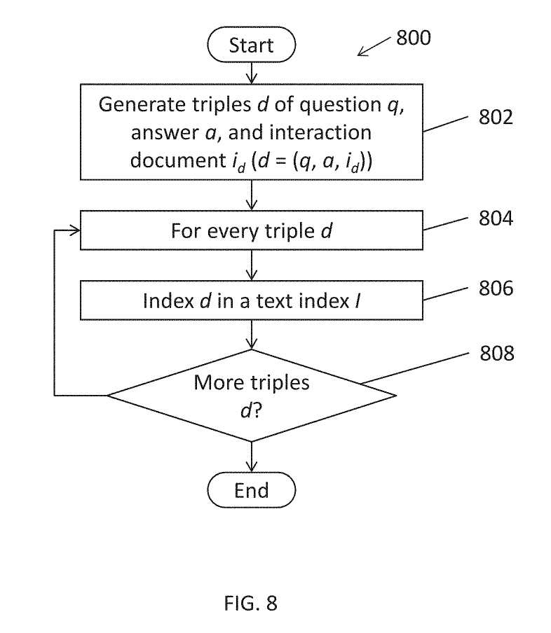

FIG. 9 is a flowchart illustrating a method for querying a Knowledge Base according to one embodiment of the present invention. Given an index I, a new question q′ and a corresponding interaction document i′_{d} in operation 902, a query Q may be generated in operation 904. The query is used to search the text index I for the best matching triple (e.g., the triple most similar to Q) in operation 906. From this top match, denoted as the triple (q*, a*, i*_{d}), the answer a* may be returned in operation 908 as the suggested answer to the new question q′ regarding interaction i′_{d}.

The pseudo code for the above described process is shown below in Table 3:

Table 3: Processes for Training and Querying a Knowledge Base (Train) For each triple d =(q, a, i_{d}) ∈ KB

a. Index d in a text index I (Query) Given a question q′ about an interaction document i′_{d}

a. Generate a query Q

b. Search I with Q

c. Take the top triple d*=(q*, a*, i*_{d})

d. Output a*

In some embodiments of the present invention, the Knowledge Base may be used to automatically answer a multiple choice question. Formally, according to one embodiment of the present invention, multiple choice questions having k different answers can be represented as a set of triples

{(q, aⱼ, i_{d})}ⱼ₌₁^{k}

The index I can be queried using a query Q that is built from a disjunction of answers:

$${{}^{k}}_{j = 1} {a}_{j}$$

In one embodiment, the set of questions q and answers a are fixed between training and querying, such that the only change between training and operation is the interaction documents i_{d}. As such, to identify, automatically, an answer a* to a known question q based on a new document i′_{d}, a query Q is generated based on the question q and the new document i′_{d} and a triple (q*, a*, i*_{d}) of the index most similar to the query Q is identified. From that identified triple, the answer a* is returned as the answer that is most likely to be the answer to question q given the new document i′_{d}.

According to another embodiment of the present invention, the training corpus is heterogeneous and contains several versions of questions having several forms (e.g., that have been updated one or more times) and may be from different customers (e.g., different contact centers) at different times. In this case, the retrieved answer a* to the question may not be one of the options in the evaluation form. As such, some embodiments of the present identify a most similar answer to the answers available using a semantic similarity heuristic Sim(a*, aᵢ) for each answer from

{aᵢ}ⱼ₌₁^{k}

where Sim is described above, for example, in the pseudocode of Table 1. By applying the similarity heuristic Sim, a most similar answer from the set of answers is chosen:

j*=ArgMaxⱼSim(a*, aⱼ)

As such, embodiments of the present invention allow the automatic identification of answers to questions of the evaluation form during the evaluation of an interaction, even if the Knowledge Base does not contain answers that are exact matches to the answer options available for the question of the evaluation form.

Some embodiments of the present invention address errors in the underlying interaction data such as the automatic speech recognition errors and typographical errors in the text chat transcripts and emails by applying a sum of word confidences instead of (or in addition to) term frequency (TF) in the framework of TF-IDF indexing.

In this way, words will be weighted in accordance with the confidence of the recognition of the word (e.g., a confidence level output by a speech recognition engine or a spelling or grammar checking engine). This method improves the retrieval performance (e.g., correctness) over term frequency counting when the confidence of the words have probabilities less than 1.

The expected value for the number of correct instances N_{w} of a word w can be approximated by the sum of the confidences:

$$E ( {N}_{w} ) = {\sum }_{i} Conf ( {w}_{i} )$$

In the case where the text is clean (e.g., accurate, spelling corrected chats or emails), the definition may be reduced to the standard term frequency definition as the number of occurrences of word w in the document.

Therefore, as discussed above, aspects of embodiments of the present invention enable the automatic or semi-automatic evaluation of an interaction based on matching of question topics with topics found in the interactions.

### Computing Devices

As described herein, various applications and aspects of the present invention may be implemented in software, firmware, hardware, and combinations thereof. When implemented in software, the software may operate on a general purpose computing device such as a server, a desktop computer, a tablet computer, a smartphone, or a personal digital assistant. Such a general purpose computer includes a general purpose processor and memory.

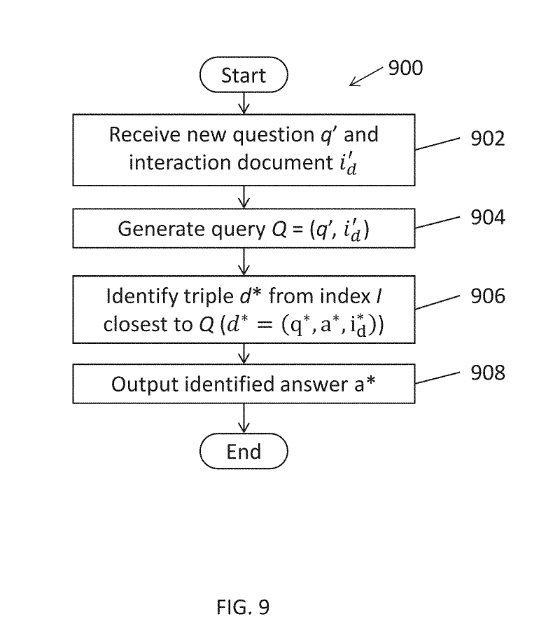

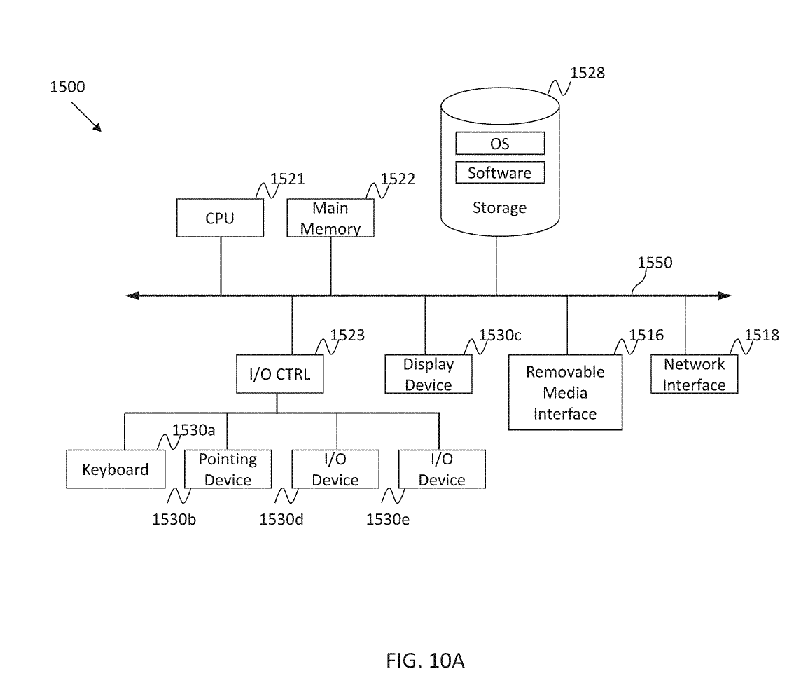

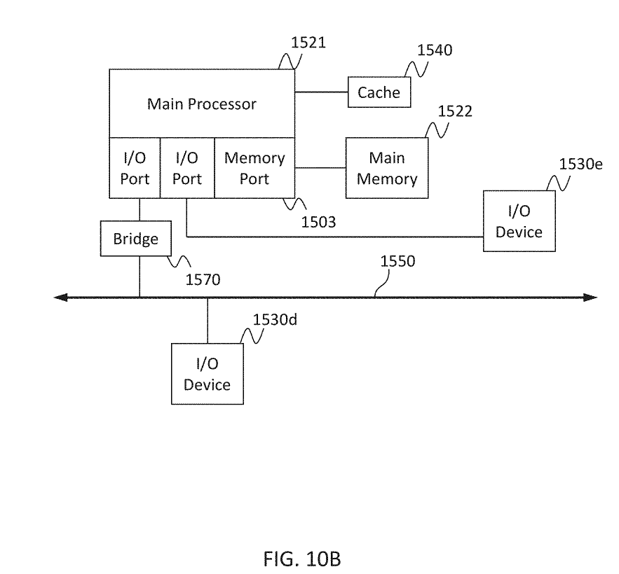

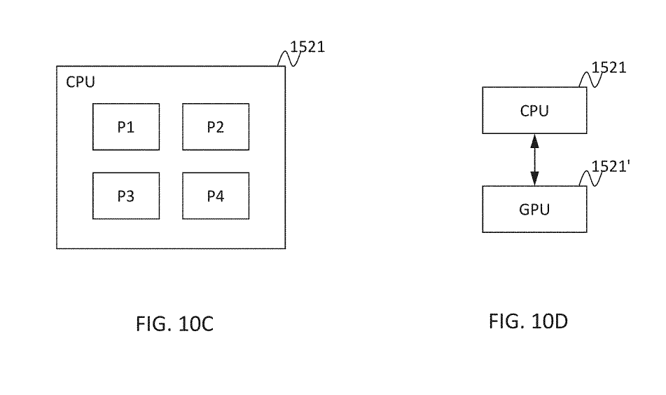

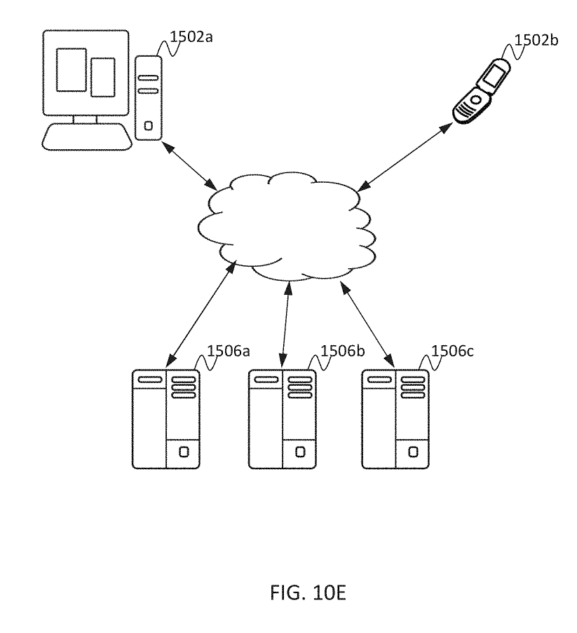

Each of the various servers, controllers, switches, gateways, engines, and/or modules (collectively referred to as servers) in the afore-described figures may be a process or thread, running on one or more processors, in one or more computing devices 1500 (e.g., FIG. 10A, FIG. 10B), executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that a computing device may be implemented via firmware (e.g. an application-specific integrated circuit), hardware, or a combination of software, firmware, and hardware. A person of skill in the art should also recognize that the functionality of various computing devices may be combined or integrated into a single computing device, or the functionality of a particular computing device may be distributed across one or more other computing devices without departing from the scope of the exemplary embodiments of the present invention. A server may be a software module, which may also simply be referred to as a module. The set of modules in the contact center may include servers, and other modules.

The various servers may be located on a computing device on-site at the same physical location as the agents of the contact center or may be located off-site (or in the cloud) in a geographically different location, e.g., in a remote data center, connected to the contact center via a network such as the Internet. In addition, some of the servers may be located in a computing device on-site at the contact center while others may be located in a computing device off-site, or servers providing redundant functionality may be provided both via on-site and off-site computing devices to provide greater fault tolerance. In some embodiments of the present invention, functionality provided by servers located on computing devices off-site may be accessed and provided over a virtual private network (VPN) as if such servers were on-site, or the functionality may be provided using a software as a service (SaaS) to provide functionality over the internet using various protocols, such as by exchanging data using encoded in extensible markup language (XML) or JavaScript Object notation (JSON).

FIG. 10A-FIG. 10B depict block diagrams of a computing device 1500 as may be employed in exemplary embodiments of the present invention. Each computing device 1500 includes a central processing unit 1521 and a main memory unit 1522. As shown in FIG. 10A, the computing device 1500 may also include a storage device 1528, a removable media interface 1516, a network interface 1518, an input/output (I/O) controller 1523, one or more display devices 1530c, a keyboard 1530a and a pointing device 1530b, such as a mouse. The storage device 1528 may include, without limitation, storage for an operating system and software. As shown in FIG. 10B, each computing device 1500 may also include additional optional elements, such as a memory port 1503, a bridge 1570, one or more additional input/output devices 1530d, 1530e and a cache memory 1540 in communication with the central processing unit 1521. The input/output devices 1530a, 1530b, 1530d, and 1530e may collectively be referred to herein using reference numeral 1530.

The central processing unit 1521 is any logic circuitry that responds to and processes instructions fetched from the main memory unit 1522. It may be implemented, for example, in an integrated circuit, in the form of a microprocessor, microcontroller, or graphics processing unit (GPU), or in a field-programmable gate array (FPGA) or application-specific integrated circuit (ASIC). The main memory unit 1522 may be one or more memory chips capable of storing data and allowing any storage location to be directly accessed by the central processing unit 1521. As shown in FIG. 10A, the central processing unit 1521 communicates with the main memory 1522 via a system bus 1550. As shown in FIG. 10B, the central processing unit 1521 may also communicate directly with the main memory 1522 via a memory port 1503.

FIG. 10B depicts an embodiment in which the central processing unit 1521 communicates directly with cache memory 1540 via a secondary bus, sometimes referred to as a backside bus. In other embodiments, the central processing unit 1521 communicates with the cache memory 1540 using the system bus 1550. The cache memory 1540 typically has a faster response time than main memory 1522. As shown in FIG. 10A, the central processing unit 1521 communicates with various I/O devices 1530 via the local system bus 1550. Various buses may be used as the local system bus 1550, including a Video Electronics Standards Association (VESA) Local bus (VLB), an Industry Standard Architecture (ISA) bus, an Extended Industry Standard Architecture (EISA) bus, a MicroChannel Architecture (MCA) bus, a Peripheral Component Interconnect (PCI) bus, a PCI Extended (PCI-X) bus, a PCI-Express bus, or a NuBus. For embodiments in which an I/O device is a display device 1530c, the central processing unit 1521 may communicate with the display device 1530c through an Advanced Graphics Port (AGP). FIG. 10B depicts an embodiment of a computer 1500 in which the central processing unit 1521 communicates directly with I/O device 1530e. FIG. 10B also depicts an embodiment in which local busses and direct communication are mixed: the central processing unit 1521 communicates with I/O device 1530d using a local system bus 1550 while communicating with I/O device 1530e directly.

A wide variety of I/O devices 1530 may be present in the computing device 1500. Input devices include one or more keyboards 1530a, mice, trackpads, trackballs, microphones, and drawing tablets. Output devices include video display devices 1530c, speakers, and printers. An I/O controller 1523, as shown in FIG. 10A, may control the I/O devices. The I/O controller may control one or more I/O devices such as a keyboard 1530a and a pointing device 1530b, e.g., a mouse or optical pen.

Referring again to FIG. 10A, the computing device 1500 may support one or more removable media interfaces 1516, such as a floppy disk drive, a CD-ROM drive, a DVD-ROM drive, tape drives of various formats, a USB port, a Secure Digital or COMPACT FLASH™ memory card port, or any other device suitable for reading data from read-only media, or for reading data from, or writing data to, read-write media. An I/O device 1530 may be a bridge between the system bus 1550 and a removable media interface 1516.

The removable media interface 1516 may for example be used for installing software and programs. The computing device 1500 may further include a storage device 1528, such as one or more hard disk drives or hard disk drive arrays, for storing an operating system and other related software, and for storing application software programs. Optionally, a removable media interface 1516 may also be used as the storage device. For example, the operating system and the software may be run from a bootable medium, for example, a bootable CD.

In some embodiments, the computing device 1500 may include or be connected to multiple display devices 1530c, which each may be of the same or different type and/or form. As such, any of the I/O devices 1530 and/or the I/O controller 1523 may include any type and/or form of suitable hardware, software, or combination of hardware and software to support, enable or provide for the connection to, and use of, multiple display devices 1530c by the computing device 1500. For example, the computing device 1500 may include any type and/or form of video adapter, video card, driver, and/or library to interface, communicate, connect, or otherwise use the display devices 1530c. In one embodiment, a video adapter may include multiple connectors to interface to multiple display devices 1530c. In other embodiments, the computing device 1500 may include multiple video adapters, with each video adapter connected to one or more of the display devices 1530c. In some embodiments, any portion of the operating system of the computing device 1500 may be configured for using multiple display devices 1530c. In other embodiments, one or more of the display devices 1530c may be provided by one or more other computing devices, connected, for example, to the computing device 1500 via a network. These embodiments may include any type of software designed and constructed to use the display device of another computing device as a second display device 1530c for the computing device 1500. One of ordinary skill in the art will recognize and appreciate the various ways and embodiments that a computing device 1500 may be configured to have multiple display devices 1530c.

A computing device 1500 of the sort depicted in FIG. 10A-FIG. 10B may operate under the control of an operating system, which controls scheduling of tasks and access to system resources. The computing device 1500 may be running any operating system, any embedded operating system, any real-time operating system, any open source operating system, any proprietary operating system, any operating systems for mobile computing devices, or any other operating system capable of running on the computing device and performing the operations described herein.

The computing device 1500 may be any workstation, desktop computer, laptop or notebook computer, server machine, handheld computer, mobile telephone or other portable telecommunication device, media playing device, gaming system, mobile computing device, or any other type and/or form of computing, telecommunications or media device that is capable of communication and that has sufficient processor power and memory capacity to perform the operations described herein. In some embodiments, the computing device 1500 may have different processors, operating systems, and input devices consistent with the device.

In other embodiments the computing device 1500 is a mobile device, such as a Java-enabled cellular telephone or personal digital assistant (PDA), a smart phone, a digital audio player, or a portable media player. In some embodiments, the computing device 1500 includes a combination of devices, such as a mobile phone combined with a digital audio player or portable media player.

As shown in FIG. 10C, the central processing unit 1521 may include multiple processors P1, P2, P3, P4, and may provide functionality for simultaneous execution of instructions or for simultaneous execution of one instruction on more than one piece of data. In some embodiments, the computing device 1500 may include a parallel processor with one or more cores. In one of these embodiments, the computing device 1500 is a shared memory parallel device, with multiple processors and/or multiple processor cores, accessing all available memory as a single global address space. In another of these embodiments, the computing device 1500 is a distributed memory parallel device with multiple processors each accessing local memory only. In still another of these embodiments, the computing device 1500 has both some memory which is shared and some memory which may only be accessed by particular processors or subsets of processors. In still even another of these embodiments, the central processing unit 1521 includes a multicore microprocessor, which combines two or more independent processors into a single package, e.g., into a single integrated circuit (IC). In one exemplary embodiment, depicted in FIG. 10D, the computing device 1500 includes at least one central processing unit 1521 and at least one graphics processing unit 1521′.

In some embodiments, a central processing unit 1521 provides single instruction, multiple data (SIMD) functionality, e.g., execution of a single instruction simultaneously on multiple pieces of data. In other embodiments, several processors in the central processing unit 1521 may provide functionality for execution of multiple instructions simultaneously on multiple pieces of data (MIMD). In still other embodiments, the central processing unit 1521 may use any combination of SIMD and MIMD cores in a single device.

A computing device may be one of a plurality of machines connected by a network, or it may include a plurality of machines so connected. FIG. 10E shows an exemplary network environment. The network environment includes one or more local machines 1502a, 1502b (also generally referred to as local machine(s) 1502, client(s) 1502, client node(s) 1502, client machine(s) 1502, client computer(s) 1502, client device(s) 1502, endpoint(s) 1502, or endpoint node(s) 1502) in communication with one or more remote machines 1506a, 1506b, 1506c (also generally referred to as server machine(s) 1506 or remote machine(s) 1506) via one or more networks 1504. In some embodiments, a local machine 1502 has the capacity to function as both a client node seeking access to resources provided by a server machine and as a server machine providing access to hosted resources for other clients 1502a, 1502b. Although only two clients 1502 and three server machines 1506 are illustrated in FIG. 10E, there may, in general, be an arbitrary number of each. The network 1504 may be a local-area network (LAN), e.g., a private network such as a company Intranet, a metropolitan area network (MAN), or a wide area network (WAN), such as the Internet, or another public network, or a combination thereof.

The computing device 1500 may include a network interface 1518 to interface to the network 1504 through a variety of connections including, but not limited to, standard telephone lines, local-area network (LAN), or wide area network (WAN) links, broadband connections, wireless connections, or a combination of any or all of the above. Connections may be established using a variety of communication protocols. In one embodiment, the computing device 1500 communicates with other computing devices 1500 via any type and/or form of gateway or tunneling protocol such as Secure Socket Layer (SSL) or Transport Layer Security (TLS). The network interface 1518 may include a built-in network adapter, such as a network interface card, suitable for interfacing the computing device 1500 to any type of network capable of communication and performing the operations described herein. An I/O device 1530 may be a bridge between the system bus 1550 and an external communication bus.

According to one embodiment, the network environment of FIG. 10E may be a virtual network environment where the various components of the network are virtualized. For example, the various machines 1502 may be virtual machines implemented as a software-based computer running on a physical machine. The virtual machines may share the same operating system. In other embodiments, different operating system may be run on each virtual machine instance. According to one embodiment, a “hypervisor” type of virtualization is implemented where multiple virtual machines run on the same host physical machine, each acting as if it has its own dedicated box. Of course, the virtual machines may also run on different host physical machines.

Other types of virtualization is also contemplated, such as, for example, the network (e.g. via Software Defined Networking (SDN)). Functions, such as functions of the session border controller and other types of functions, may also be virtualized, such as, for example, via Network Functions Virtualization (NFV).

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A method comprising:
receiving, by a processor, a question comprising text;
identifying, by the processor, one or more identified topics from a plurality of tracked topics tracked by an analytics system in accordance with the text of the question, the analytics system being configured to perform analytics on a plurality of interactions with a plurality of agents of a contact center;
outputting, by the processor, the one or more identified topics;
associating, by the processor, one or more selected topics with the question, the selected topics one or more of the identified topics;
adding, by the processor, the question and the selected topics to the evaluation form; and
outputting the evaluation form.

2. The method of claim 1, wherein the identifying the one or more identified topics from a plurality of tracked topics tracked by the analytics system in accordance with the text of the question comprises, for each topic of the plurality of tracked topics:
computing a question-topic similarity metric between the text of the question and the topic; and
connecting the topic to the question when the question-topic similarity metric exceeds a threshold.

3. The method of claim 2, wherein the computing the question-topic similarity metric between the text of the question and the topic comprises:
computing a plurality of word similarity metrics, each word similarity metric corresponding to a similarity between a stemmed word of the text of the question and a most similar stemmed word in the topic; and
summing the plurality of word similarity metrics to compute the question-topic similarity metric.

4. The method of claim 3, further comprising:
normalizing the question-topic similarity metric by a number of unique stemmed words in the text of the question.

5. The method of claim 1, further comprising receiving a data type of answers to the question, the data type being one of:
a yes/no data type;
a multiple response data type;
a numerical value data type; and
a free text data type.

6. The method of claim 1, further comprising:
associating the evaluation form with an evaluation session;
associating one or more interactions to the evaluation session; and
identifying and associating one or more evaluators to the evaluation session.

7. A method for evaluating an interaction between a customer and an agent of a contact center, the method comprising:
outputting, by a processor, an evaluation form comprising a plurality of questions, each of the plurality of questions being associated with one or more question topics;
outputting, by the processor, the interaction, the interaction being associated with one or more interaction topics, each of the one or more interaction topics being associated with at least one portion of the interaction; and
for each question of the plurality of questions:
identifying, by the processor, at least one portion of the interaction relevant to the question, the at least one portion corresponding to one of the interaction topics, wherein the one of the interaction topics corresponds to one of the question topics; and
receiving, by the processor, an answer to the question.

8. The method of claim 7, wherein the identifying the at least one portion of the interaction relevant to the question comprises highlighting the at least one portion on a user interface device.

9. The method of claim 7, wherein the identifying the at least one portion of the interaction relevant to the question comprises displaying a representation of the interaction on a user interface device and displaying at least one icon at location of the representation of the interaction corresponding to the at least one portion.

10. The method of claim 7, wherein the interaction is a recording, and
wherein the identifying the at least one portion of the interaction relevant to the question comprises automatically playing back the relevant portion of the interaction.

11. The method of claim 7, further comprising, for each question of the questions:
determining whether question is relevant to the interaction; and
hiding the question when the question is irrelevant to the interaction.

12. The method of claim 7, wherein, when the question is a multiple response question comprising a plurality of answers, each of the answers of the multiple response question is associated with one or more question-answer topics, and
wherein the identifying, by the processor, at least one portion of the interaction relevant to the question comprises identifying at least one portion corresponding to one of the interaction topics corresponding to one of the question-answer topics.

13. A method for evaluating an interaction in accordance with an evaluation form comprising a plurality of questions, the method comprising:
for each current question of the plurality of questions:
generating a query in accordance with the current question and the interaction;
querying a knowledge base based on the question and the interaction, the knowledge base comprising an index of a plurality of triples, each triple comprising a question, an answer, and an interaction document;
identifying a closest matching triple of the plurality of triples of the knowledge base in accordance with the current question and the interaction; and
outputting the answer of the closest matching triple.

14. The method of claim 13, wherein the knowledge base is generated from a plurality of evaluations of a plurality of previously evaluated interactions.
